(19) United States
(12) Patent Application Publication
(10) Pub. No.: US 2009/0014521 A1
(43) Pub. Date: Jan. 15, 2009

(54) CARD READER

(75) Inventors: CHI-TUNG CHANG, TAIPEI (TW); SHIH-MIN LAN, TAIPEI (TW); I-CHIEH LIN, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: ALCOR MICRO CORP., TAIPEI (TW)

(21) Appl. No.: 11/775,992

(22) Filed: Jul. 11, 2007

(51) Int. Cl. G06K 7/06

(52) U.S. Cl. 235/441

(57) ABSTRACT

A card reader that can enhance the efficiency of the application system is embedded in the application system. The application system has an external memory drive. The card reader includes at least one memory card connector, a flash memory, and a control unit. The memory card connector is used for being plugged with a memory card. The flash memory is driven and integrated by the external memory drive. The control unit is electrically connected with the memory card connector and the flash memory and is used for transmitting data between the memory card and the flash memory and the application system via the control unit. Thereby, the flash memory can be used as an extended memory of the application system. The total memory of the application system increases, and the efficiency of the application system is enhanced.

### BACKGROUND OF THE INVENTION

1. Field of the Invention

The present invention relates to a card reader. In particular, this invention relates to a card reader that is embedded in the application system and enhances the efficiency of the application system.

2. Description of the Related Art

Because the computer becomes popular, people uses the computers everyday, including working, entertaining, and learning, etc. As the technology has been rapidly developed, the relative fields for the computer, such as the hardware, the application software, or the operating system, are continuously developed and updated.

For the user, the updating frequency for the computer hardware is lower than one of the application software. This means that the same hardware can meet the requirements for a variety of application software. However, because the functions of the operating system increase and the operating system integrates a large amount of application software, the hardware resource occupied by the operating system also increases. When the user wishes to update the computer with a new operating system, the user has to update the computer hardware increase the operation efficiency. If the user does not update the hardware, the operating system will not work smoothly and the application software that is installed at the operating system cannot work in an optimum status.

The main method to increase the efficiency of the computer hardware is increase the capacity of the DRAM. However, by adding the system DRAM increase the efficiency of the computer hardware, the cost increases. Furthermore, the user also needs to consider the compatibility of the motherboard, or the quantity can be added to the motherboard. Sometimes, the user must replace the all system DRAM and/or the motherboard with new ones. The cost increases.

On the other hand, because the memory card are popular for the user, people usually uses a card reader to access the memory card. The card reader of the prior art has a lot of characteristics, including it is convenient for the user to carry it, a variety of memory cards are supported, and it is convenient to transmit data with the computer, etc. The card reader is a popular interface between the memory card and the computer. Therefore, how to increase the efficiency of the application system when the user buys a card reader is a concerned topic.

### SUMMARY OF THE INVENTION

One particular aspect of the present invention is to locate the flash memory in the card reader, and cooperate with the program that is integrated with the memory managing function in the application system to use the flash memory as the system DRAM. Thereby, the system DRAM is expanded and the efficiency of the application system is enhanced. Therefore, the user can use the application functions of the card reader, and expand the system DRAM of the application system to increase the efficiency of the application system.

The card reader that can enhance the efficiency of the application system is embedded in the housing of the application system. The application system has an external memory drive. The card reader includes at least one memory card connector, a flash memory, and a control unit. The memory card connector is used for being plugged with a memory card that has the same format with the memory card connector. When the external memory drive is enabled, the flash memory is a memory that is used for driving and integrating. The control unit is electrically connected with the memory card connector and the flash memory, and is used for connecting with the application system so that the memory card and the flash memory can transmit data with the application system via the control unit. Thereby, the flash memory is integrated by the external memory drive to be an extended memory of the application system. The total memory of the application system increases, and the efficiency of the application system is enhanced.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the application of the card reader that can enhance the efficiency of the application system of the present invention;

FIG. 2 is a block diagram of the card reader that can enhance the efficiency of the application system of the present invention; and

FIG. 3 is a circuit diagram of part of the circuits of the card reader of the present invention.

### DETAILED DESCRIPTION OF THE PREFERRED EMBODIMENTS

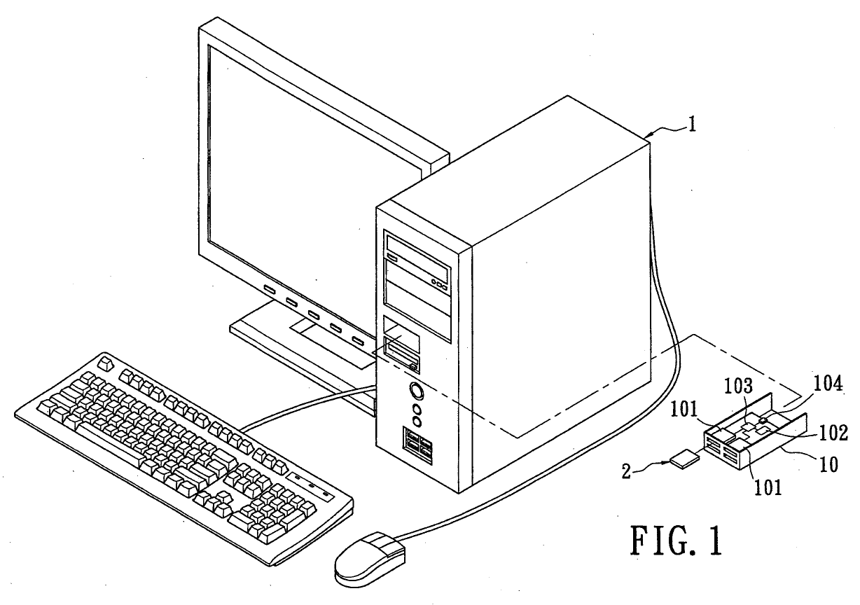

Reference is made to FIG. 1, which shows a schematic diagram of the application of the card reader that can enhance the efficiency of the application system of the present invention. The card reader 10 is embedded in an application system 1. In this embodiment, the application system 1 is a desktop computer. Alternatively, the application system 1 can be a laptop or a device with the operating system.

The card reader 10 includes at least one memory card connector 101, a flash memory 102, a control unit 103, and an interface connection port 104. The memory card connector 101 is used for being plugged with a memory card 2 that has the same format with the memory card connector 101 by the user. In this embodiment, there are four memory card connectors 101. Each of the memory card connectors 101 is plugged with a memory card 2 (such as a compact flash card—CF card). Thereby, the data can be accessed between the memory card 2 and the application system 1 via the card reader 10. The memory card connector 101 can be a memory card connector with a single format, or a memory card connector with multiple formats.

The flash memory 102 (such as a NAND flash memory) can be accessed by the user, and can be used as an extended memory of the application system 1. The application system 1 integrates the flash memory 102 to be used as an extended memory of the application system 1 and increase the capacity of the memory to enhance the efficiency of the application system 1. The control unit 103 is connected with the application system 1 so that the application system 1 can transmit data with the memory card and/or the flash memory via the card reader 10.

The interface connection port 104 is connected with the application system 1 via a signal connecting wire (not shown in the figure) to transmit data. Because the card reader 10 is a built-in card reader 10, the flash memory 101 always can be used as the extended memory of the application system 1. Therefore, the user does not need to transmit data in the flash memory 102 to a fixed storage device (such as the hard disk) of the application system 1 before the portable storage device is removed from the interface connection port 104. The system resource is not occupied.

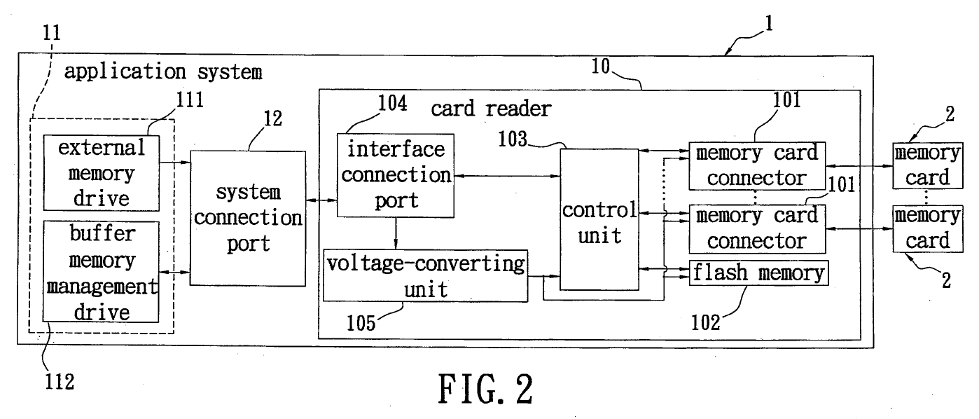

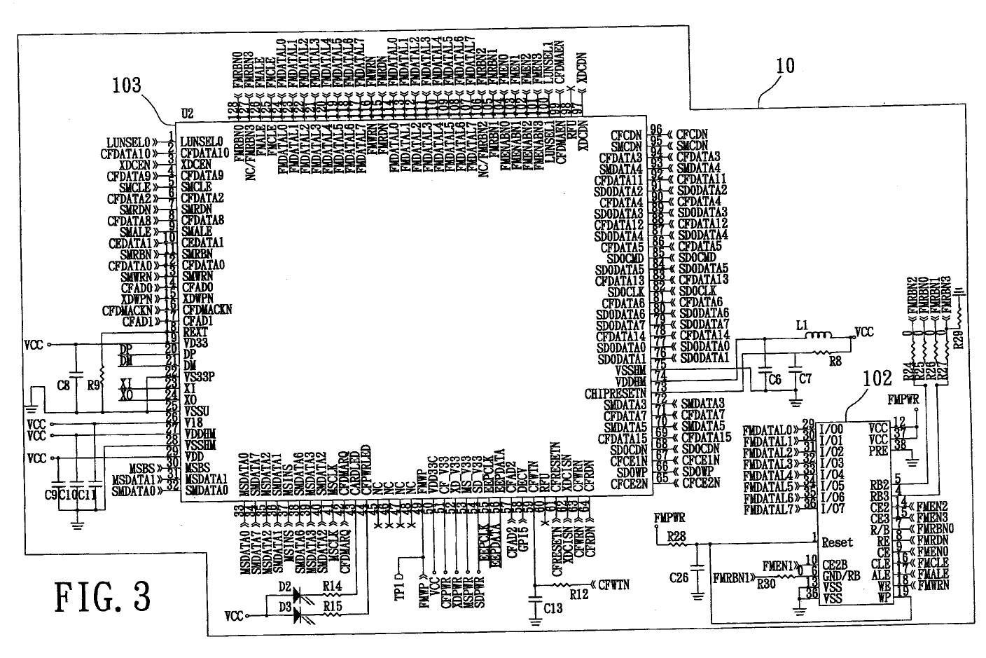

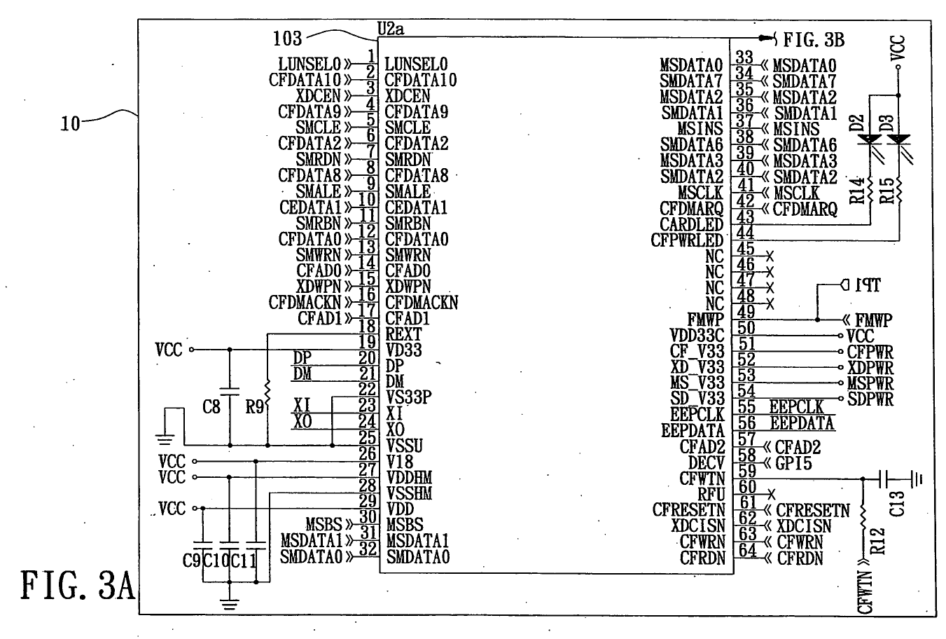

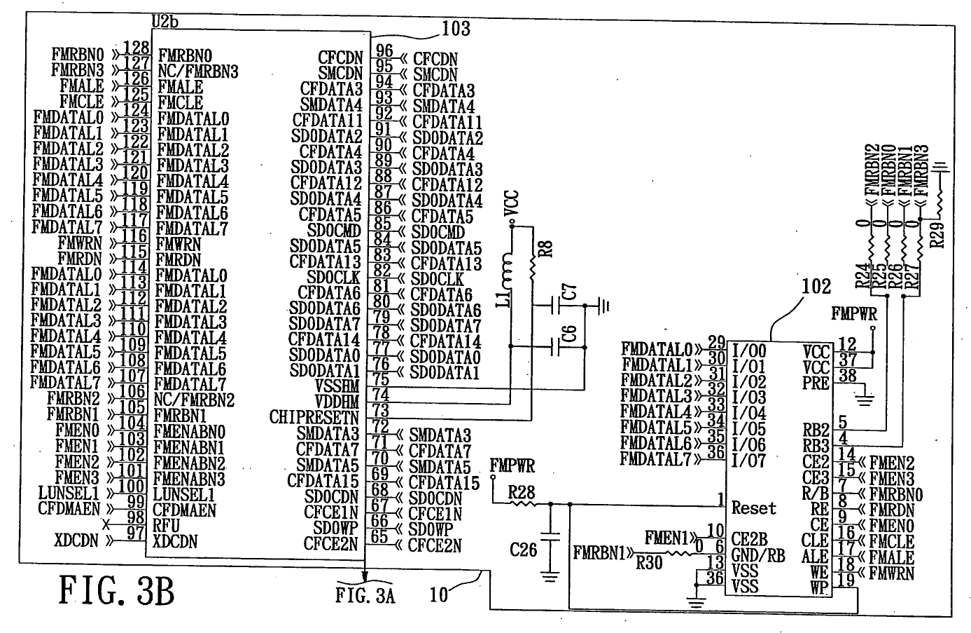

Reference is made to FIGS. 2 and 3, which show a block diagram of the card reader that can enhance the efficiency of the application system of the present invention and a circuit diagram of part of the circuits of the card reader of the present invention. The application system 1 has an external memory drive 111. When the application system 1 is turned on, the application system 1 executes the external memory drive 111 to drive and integrate the flash memory 102 in the card reader 10 so that the flash memory 102 is used as an extended memory of the application system 1. Both the flash memory 102 and the original system DRAM can be accessed by the application system 1. This means that the available memory capacity of the application system 1 increases. Therefore, the efficiency of the application system 1 is enhanced due to the application system 1 is embedded with the card reader 1.

The memory card connector 101 is used for being plugged with a memory card 2 by the user. The control unit 103 is electrically connected with the memory card connector 101, the flash memory 102 and the application system 1 so that the memory card 2 and the flash memory 102 can transmit data with the application system 1 via the control unit 103. The interface connection port 104 is electrically connected with the control unit 103, and is plugged with a system connection port 12 of the application system 1 to transmit the data between the control unit 103 and the application system 1. In this embodiment, the interface connection port 104 and the system connection port 12 can be a USB interface or a SATA interface.

The card reader 10 further includes a voltage-converting unit 105 electrically connected with the interface connection port 104 fro receiving a system voltage (such as 5 volts) transmitted by the interface connection port 104. Next, the system voltage is converted into an output voltage (such as 3.3 volts) and the output voltage is provided to the control unit 103, the memory card 2 and the flash memory 102. In this embodiment, the voltage-converting unit 105 is located at outside of the control unit 103. Alternatively, the voltage-converting unit 105 can be located in the control unit 103 to reduce the cost.

The application system also includes a buffer memory management drive 112 for managing the total memory in the application system 1 that has been integrated by the external memory drive 111. Thereby, the application system 1 can fully utilize all of the memory, and has enough capacity to preload files that are usually used by the user and enhances the response time of the application system 1. In this embodiment, the buffer memory management drive 112 and the external memory drive 111 can be stored in a storage device 11 of the application system 1, and integrates and manages the flash memory 102 in the card reader 10 via connecting the system connection port 12 and the interface connection port 104. Alternatively, the buffer memory management drive 112 and the external memory drive 111 can be built-in the operating system of the application system 1 (such as the Ready Boost and the Ready-Drive of the Microsoft Vista), or an application program attached onto the operating system 1.

When the card reader 10 is operated with the application system 1, the control unit 103 in the card reader 10 individually set different logic unit numbers to the flash memory 102 and the memory card connector 102 so that the flash memory 102 and the memory card connector 102 are independent logic units. Therefore, the card reader 10 in the application system 1 can be labeled by a different drive label. For example, the card reader 10 has four memory card connectors 101 and a flash memory 102. Five removable drives are displayed on the application system 1. Therefore, the flash memory 102 can be an extended memory for the application system 1. Alternatively, the flash memory 102 also can be a storage device for storing data files.

By embedding the card reader in the application system, the flash memory of the card reader that enhances the efficiency of the application system can used as the extended memory of the application system forever to maintain the efficiency of the application system. When the user buys the card reader, the user can access the memory card and increase the efficiency of the application system. Therefore, the functions of the card reader are versatile.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A card reader, accessed by an application system to enhance the efficiency of the application system, comprising:
at least one memory card connector used for being plugged with a memory card, wherein a format of the memory card is the same as the memory card connector;
a flash memory used as an extended memory of the application system; and
a control unit electrically connected with the memory card connector and the flash memory, wherein the control unit controls the memory card and the flash memory to transmit data with the application system.

2. The card reader as claimed in claim 1, wherein the card reader is embedded into the application system.

3. The card reader as claimed in claim 1, wherein the memory card connector is a memory card connector with a single format, or a memory card connector with multiple formats.

4. The card reader as claimed in claim 1, wherein the control unit uses different logic unit numbers to control the memory card connector and the flash memory and treats the memory card connector and the flash memory as independent logic units.

5. The card reader as claimed in claim 1, further comprising an interface connection port electrically connected with the control unit, wherein the interface connection port is plugged with a system connection port of the application system to transmit data converted between the control unit and the application system.

6. The card reader as claimed in claim 5, wherein the interface connection port is a USB interface or a SATA interface.

7. The card reader as claimed in claim 5, wherein further comprising a voltage-converting unit electrically connected with the interface connection port, wherein the voltage-converting unit receives a system voltage transmitted by the interface connection port and converts the system voltage into an output voltage for the control unit, the memory card connector and the flash memory.

8. An application system comprising the card reader of claim 1.

9. The application system as claimed in claim 8, wherein the application system further comprises an external memory drive for driving and integrating the flash memory to be an extended memory of the application system.

10. The application system as claimed in claim 9, wherein the application system further comprises a buffer memory management drive for connecting and managing the extended memory of the application system.

11. The application system as claimed in claim 10, wherein the external memory drive and the buffer memory management drive are located in a storage device of the application system.
